(19) United States
(12) Patent Application Publication
(10) Pub. No.: US 2020/0249464 A1
(43) Pub. Date: Aug. 6, 2020

(54) OPTICAL DEVICE FOR LIGHT DELIVERY

(71) Applicant: Thorlabs, Inc., Newton, NJ (US)

(72) Inventors: Jeffrey S. Brooker, Manassas, VA (US); Hongzhou MA, Centreville, VA (US)

(21) Appl. No.: 16/777,313

(22) Filed: Jan. 30, 2020

Related U.S. Application Data
(60) Provisional application No. 62/799,495, filed on Jan. 31, 2019.

(51) Int. Cl. G02B 26/08; G02B 27/00; G02B 21/18

(52) U.S. Cl. CPC G02B 26/0816; G02B 21/18; G02B 27/0012

(57) ABSTRACT

An optical device includes: first and second optical paths; a light reflective surface; and a linkage system. The first optical path is defined along a first optical axis. The second optical path is defined along a second optical axis. The light reflective surface is defined between the first and second optical paths. The first and second axes define first and second tilt angles from a normal line of the reflective surface, respectively. The linkage system connects the first and second optical paths with the light reflective surface such that the first tilt angle remains the same as the second tilt angle during movement of the first optical path relative to the second optical path.

### CROSS REFERENCES TO RELATED APPLICATIONS

This application claims the benefit of U.S. Provisional Patent Application No. 62/799,495 filed on Jan. 31, 2019. The disclosure and entire teachings of U.S. Provisional Patent Application 62/799,495 are hereby incorporated by reference.

### FIELD OF THE INVENTION

The present disclosure generally relates to an optical device for light delivery.

### BACKGROUND

In optical systems where there is a relative motion in the optical path, rotary joints and mirrors in the joints may be used to allow deflection of light to the targeted direction. Typically, each rotary joint may provide only one degree of freedom of motion in the optics path. In some cases, a large number of rotary joints and mirrors are used to direct light to the targeted direction. This may increase space that is needed for the whole system and may reduce the light amount until the light reaches the targeted location due to multiple reflections at the mirrors.

Therefore, there is a need for optical systems so that space for an optical system can be saved and/or reduction of the light amount may be suppressed.

### SUMMARY

An embodiment of the present disclosure provides an optical device. The optical device includes: first and second optical paths; a light reflective surface; and a linkage system. The first optical path is defined along a first optical axis. The second optical path is defined along a second optical axis. The light reflective surface is defined between the first and second optical paths. The first and second axes define first and second tilt angles from a normal line of the reflective surface, respectively. The linkage system connects the first and second optical paths with the light reflective surface such that the first tilt angle remains the same as the second tilt angle during movement of the first optical path relative to the second optical path.

Another embodiment of the present disclosure provides an optical apparatus. The optical apparatus includes: a microscope including a light source; and an optical device. The optical device includes: first and second optical paths; a light reflective surface; and a linkage system. The first optical path is defined along a first optical axis. The second optical path is defined along a second optical axis. The light reflective surface is defined between the first and second optical paths. The first and second axes define first and second tilt angles from a normal line of the reflective surface, respectively. The linkage system connects the first and second optical paths with the light reflective surface such that the first tilt angle remains the same as the second tilt angle during movement of the first optical path relative to the second optical path. The optical device is configured to direct a light from the light source.

### BRIEF DESCRIPTION OF THE DRAWINGS

FIGS. 1A-1C illustrate schematic views of an optical system with respective tilt angles according to one embodiment of the present disclosure.

FIGS. 2 and 3 illustrate front views of an optical device with respective tilt angles according to one embodiment of the present disclosure.

FIGS. 4 and 5 illustrate front views of an optical device with respective tilt angles according to another embodiment of the present disclosure.

FIGS. 6 and 7 illustrate front views of an optical device with respective tilt angles according to another embodiment of the present disclosure.

FIGS. 8 and 9 are photographs of an optical device with respective tilt angles according to one embodiment of the present disclosure.

FIG. 10 is a perspective view of a microscope mounted on a hexapod according to an embodiment.

FIG. 11 is a perspective view of a hexapod according to an embodiment.

### DETAILED DESCRIPTION OF THE PREFERRED EMBODIMENTS

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

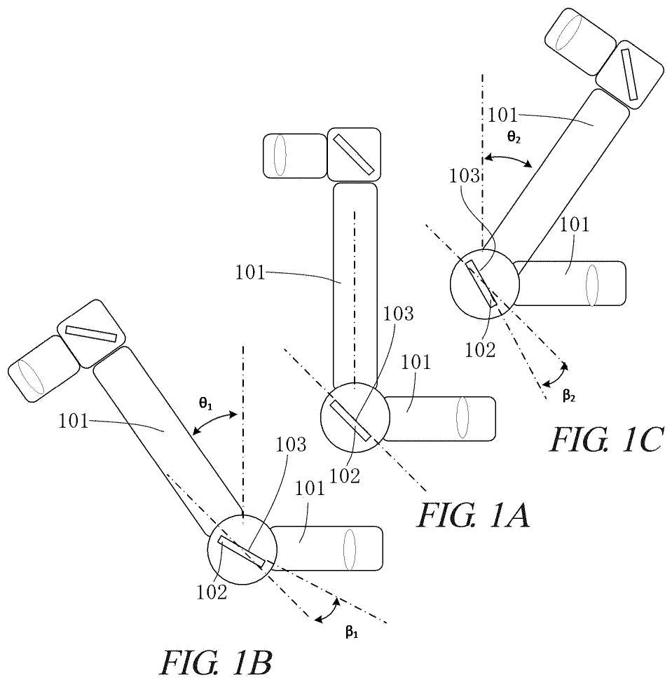

FIGS. 1A-1C illustrate schematic views of an optical system according to one embodiment of the present disclosure.

The optical system shown in FIGS. 1A-1C may be configured to allow deflection of light to a targeted direction. The optical system in this embodiment may deliver light through free space that follows the motion of the opto-mechanical system. In the present disclosure, light may include, but not limited to, a visible ray, an ultra-violet ray, an infrared ray, laser beams in the visible region and outside the visible region, an optical image, any combination thereof, and other type of light.

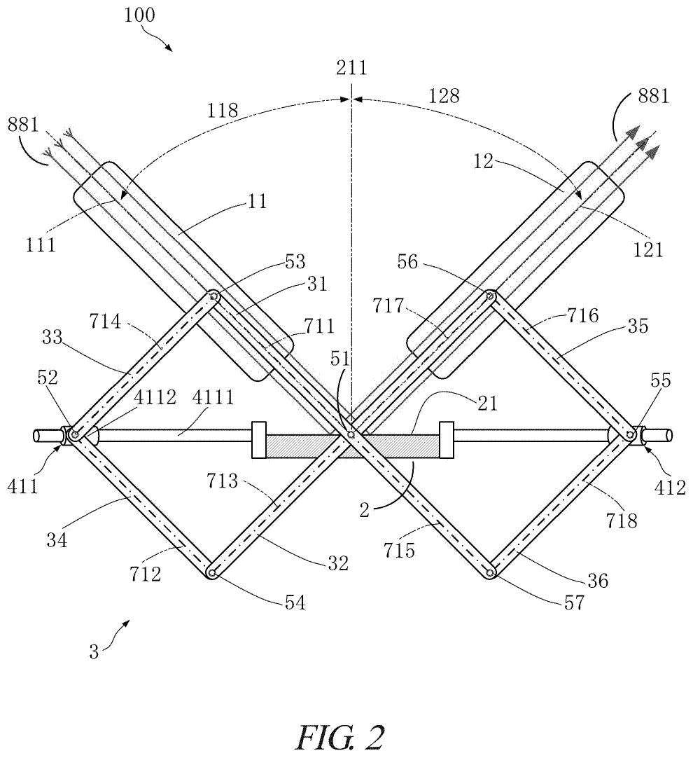

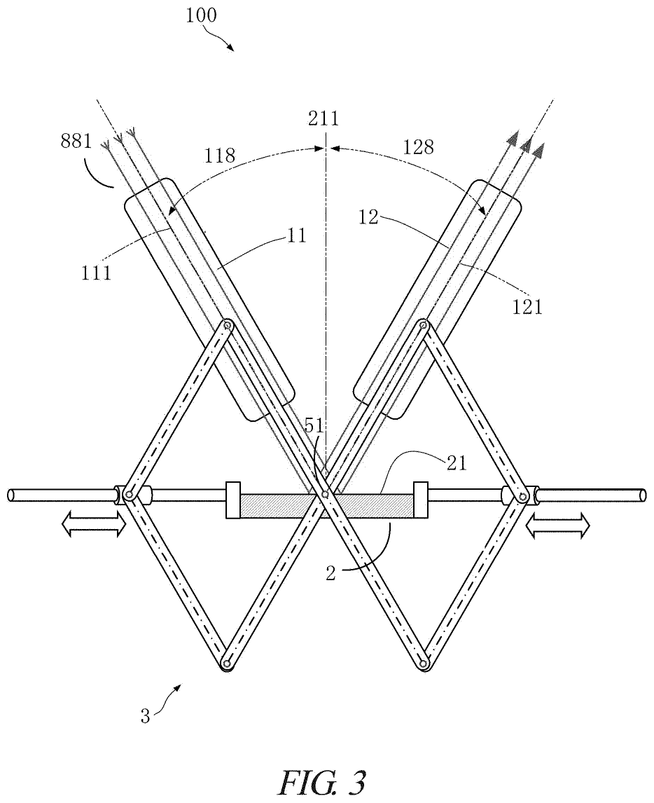

The system in FIGS. 1A-1C may be configured to tilt an incident path relative to the reflective path or vice versa. The system may include optical paths 101 and a mirror 102 that includes a reflective surface 103. In one example, the optical paths 101 may include, but not limited to, lens tubes and other types of optical paths. If there is an angle change of θ, the reflective surface 103 of the mirror 102 therefore may need to turn by θ/2 to deflect the image or light along the tilted optics axis. For example, in FIG. 1A, the original angle of the reflective surface 103 of the mirror 102 is at 45°. As shown in FIG. 1B, when one optical path 101 tilts by angle θ₁, the reflective surface 103 of the mirror 102 may need to tilt by β₁. As shown in FIG. 1C, when one optical path 101 tilts by angle θ2, the reflective surface 103 of the mirror 102 may need to tilt by (32. To ensure that light follows the tilting, the reflective surface 103 of the mirror 102 may need to tilt by an angle such that β₁=½ θ₁ and β₂=½ θ₂. In another word, an angle between an optical axis of one optical path 101 and a normal line of the reflective surface 103 of the mirror 102 may have to remain the same as an angle between an optical axis of the other optical path 101 and the normal line of the reflective surface 103 of the mirror 102. The following examples in view of FIGS. 2-7 may satisfy such requirement.

FIGS. 2 and 3 illustrate front views of an optical device according to one embodiment of the present disclosure.

The optical device 100 in FIGS. 2 and 3 may include a first optical path 11, a second optical path 12, a mirror 2, and a linkage system 3. In one example, light 881 may enter the first optical path 11. Then, the light 881 may proceed along the first optical path 11, be reflected by the mirror 2, and then proceed along the second optical path 12. Then, the light 881 may be emitted from the second optical path 12. In another example, a light may enter the second optical path 12, be reflected by the mirror 2, and be emitted from the first optical path 11. The first optical path 11 may be defined along a first optical axis 111. The second optical path 12 may be defined along a second optical axis 121. The second optical path 12 may move relative to the first optical path 11. The mirror 2 may include a reflective surface 21. The reflective surface 21 may be flat, and may be defined between the first and second optical paths 11 and 12. The first and second optical axes 111 and 121 may define first and second tilt angles 118 and 128 from a normal line 211 of the reflective surface 21, respectively. The linkage system 3 may connect the first and second optical paths 11 and 12 with the light reflective surface 21 such that the first tilt angle 118 remains the same as the second tilt angle 128 during movement of the first optical path 11 relative to the second optical path 12.

In the illustrated example of FIGS. 2 and 3, the linkage system 3 may include a first bar 31, a second bar 32, a third bar 33, a fourth bar 34, a fifth bar 35, and sixth bar 36. In one embodiment, the bars 31-34 may form a parallelogram, and the bars 31-32 and 35-36 may form another parallelogram. Each of the bars may include the shape of, for example, without limitation, a straight shape, a curved shape, combination thereof, and other type of shapes.

In FIGS. 2 and 3, the bars 31 and 32 may pivotally connect at a first joint 51, the bars 33 and 34 may pivotally connect at a second joint 52, the bars 31 and 33 may pivotally connect at a third joint 53, the bars 32 and 34 may pivotally connect at a fourth joint 54, the bars 35 and 36 may pivotally connect at a fifth joint 55, the bars 34 and 35 may pivotally connect at a sixth joint 56, and the bars 31 and 36 may pivotally connect at a seventh joint 57.

In the illustrated example, the first joint 51 may be connected to the reflective surface 21, for example, without limitation, at a center of the reflective surface 21. The first optical axis 111 and the second optical axis 121 may cross at the first joint 51 and on the reflective surface 21. The third joint 53 may be connected to the first optical path 11. The second joint 52 may be connected to a first slide structure 411. Therefore, the second joint 52 may slidably move by the first slide structure 411. In FIGS. 2-3, the first slide structure 411 may include a rod 4111 and a sliding tube 4112. The rod 4111 may extend, for example, parallel to or normal to the reflective surface 21 of the mirror 2. In the illustrated example, the rod 4111 may be connected to the mirror 2, and extend parallel to the reflective surface 21 of the mirror 2. The sliding tube 4112 may be connected to the first slide structure 411, and be slidable along the rod 4111. In other examples (not shown), the first slide structure may include: a channel and a sliding block slidable along the channel; a rail and a wheel slidable along the rail; or other similar linear sliding mechanisms.

In the illustrated example, the sixth joint 56 may be connected to the second optical path 12. The fifth joint 55 may be connected to a second slide structure 412. Therefore, the fifth joint 55 may slidably move by the second slide structure 412. The second slide structure 412 may have the same or similar configurations of the first slide structure 411 discussed above.

As shown in FIGS. 2 and 3, the second joint 52 may be constrained by the first slide structure 411 and the fifth joint 55 may be constrained by the second slide structure 412, such that the bars 31 and 32 may pivot around the first joint 51. In the illustrated example, the second joint 52 and the fifth joint 55 may be constrained to move parallel to the reflective surface 21 of the mirror. As shown in FIGS. 2-3, when the bars 31 and 32 pivot around the first joint 51, the first optical path 11 and the second optical path 12 may pivot around the first joint 51. During the movement of the first optical path 11 relative to the second optical path 12, a line 711 extending from the first joint 51 to the third joint 53 may remain parallel to a line 712 extending from the fourth joint 54 to the second joint 52. During the movement of the first optical path 11 relative to the second optical path 12, a line 713 extending from the first joint 51 to the fourth joint 54 may remain parallel to a line 714 extending from the third joint 53 to the second joint 52.

Similar to the lines 711-714, during the movement of the first optical path 11 relative to the second optical path 12, a line 715 extending from the first joint 51 to the seventh joint 57 may remain parallel to a line 716 extending from the sixth joint 56 to the fifth joint 55. During the movement of the first optical path 11 relative to the second optical path 12, a line 717 extending from the first joint 51 to the sixth joint 56 may remain parallel to a line 718 extending from the seventh joint 57 to the fifth joint 55.

As discussed, the pairs of the lines 711-718 may remain parallel and the first optical axis 111 and the second optical axis 121 may pivot around the first joint 51 located on the reflective surface 21. Therefore, the first and second tilt angles 118 and 128 may remain the same during the movement of the first optical path 11 relative to the second optical path 12. As such, the chance of the light 881 not translating from an optical path (e.g., the second optical path 12) or de-centering from an optical path (e.g., the second optical path 12) may be decreased.

In addition, since the present embodiment may define desired incident angle and reflective angle of the light 881 without employing a number of joints and mirrors, space for an optical system can be saved and/or reduction of the light amount until a targeted location may be suppressed.

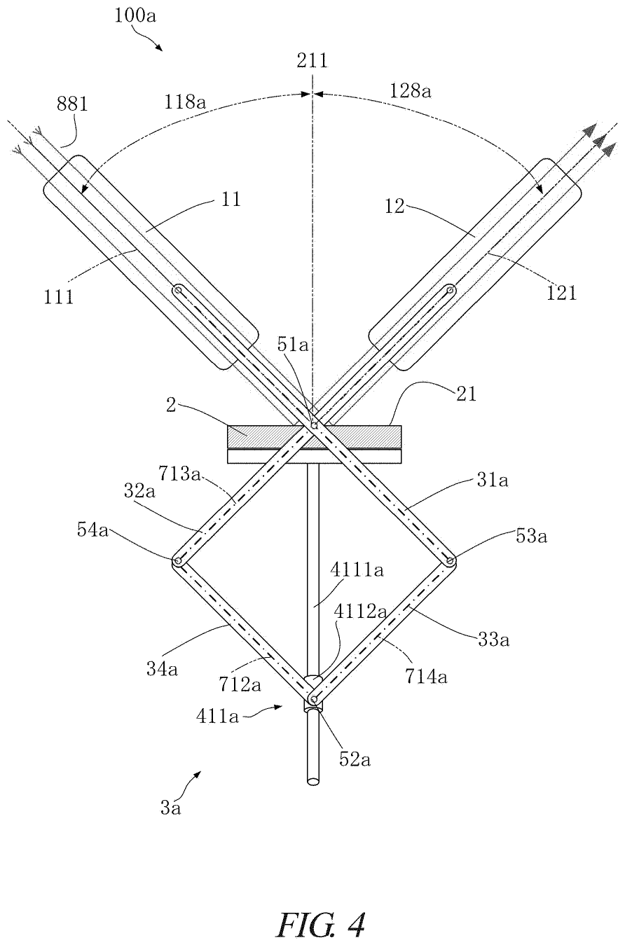

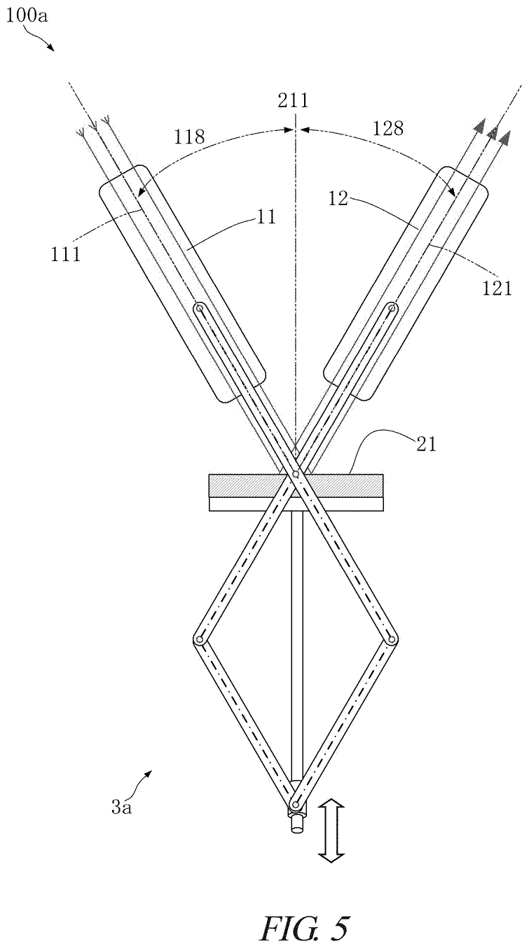

FIGS. 4 and 5 illustrate front views of an optical device according to another embodiment of the present disclosure.

The optical device 100a in FIGS. 4 and 5 may include the first optical path 11, the second optical path 12, the mirror 2, and a linkage system 3a. The optical paths 11 and 12 and the mirror 2 in FIGS. 4 and 5 are the same as or similar to those of FIGS. 2 and 3. In the embodiment of FIGS. 4 and 5, the linkage system 3a may include a first bar 31a, a second bar 32a, a third bar 33a, and a fourth bar 34a. In one embodiment, the bars 31a-34a may form a parallelogram.

In FIGS. 4 and 5, the bars 31a and 32a may pivotally connect at a first joint 51a, the bars 33a and 34a may pivotally connect at a second joint 52a, the bars 31a and 33a may pivotally connect at a third joint 53a, the bars 32a and 34a may pivotally connect at a fourth joint 54a.

In the illustrated example, the first joint 51a may be connected to the reflective surface 21, for example, without limitation, at a center of the reflective surface 21. The first optical axis 111 and the second optical axis 121 may cross at the first joint 51a and on the reflective surface 21. The second joint 52a may be connected to a slide structure 411a. Therefore, the second joint 52a may slidably move by the slide structure 411a. In FIGS. 4 and 5, the slide structure 411a may include a rod 4111a and a sliding tube 4112a. The rod 4111a may extend, for example, parallel to or normal to the reflective surface 21 of the mirror 2. In the illustrated example, the rod 4111a may be connected to the mirror 2 (in a non-limiting example, at a bottom of the mirror 2), and extend normal to the reflective surface 21 of the mirror 2. The sliding tube 4112a may be connected to the slide structure 411a, and be slidable along the rod 4111a. In other examples, the first slide structure may include: a channel and a sliding block slidable along the channel; a rail and a wheel slidable along the rail; or other similar linear sliding mechanisms.

In one embodiment, the second joint 52a may be constrained by the slide structure 411a, such that the bars 31a and 32a may pivot around the first joint 51a. In the illustrated example, the second joint 52a may be constrained to move normal to the reflective surface 21 of the mirror. As shown in FIGS. 4-5, when the bars 31a and 32a pivot around the first joint 51a, the first optical path 11 and the second optical path 12 may pivot around the first joint 51a. During the movement of the first optical path 11 relative to the second optical path 12, a line 711a extending from the first joint 51a to the third joint 53a may remain parallel to a line 712a extending from the fourth joint 54a to the second joint 52a. During the movement of the first optical path 11 relative to the second optical path 12, a line 713a extending from the first joint 51a to the fourth joint 54a may remain parallel to a line 714a extending from the third joint 53a to the second joint 52a.

In this embodiment, the pairs of the lines 711a-714a may remain parallel and the first optical axis 111 and the second optical axis 121 may pivot around the first joint 51a located on the reflective surface 21. Therefore, the first and second tilt angles 118a and 128a may remain the same during the movement of the first optical path 11 relative to the second optical path 12. As such, the chance of the light 881 not translating from an optical path (e.g., the second optical path 12) or de-centering from an optical path (e.g., the second optical path 12) may be decreased. Further, space for an optical system can be saved and/or reduction of the light amount until a targeted location may be suppressed. In addition, the linkage system 3a of FIGS. 4 and 5 may have simplified structure compared to the linkage system 3 of FIGS. 2 and 3. Further, the lower part of the bars of the linkage system 3a may cut to reduce overall dimension.

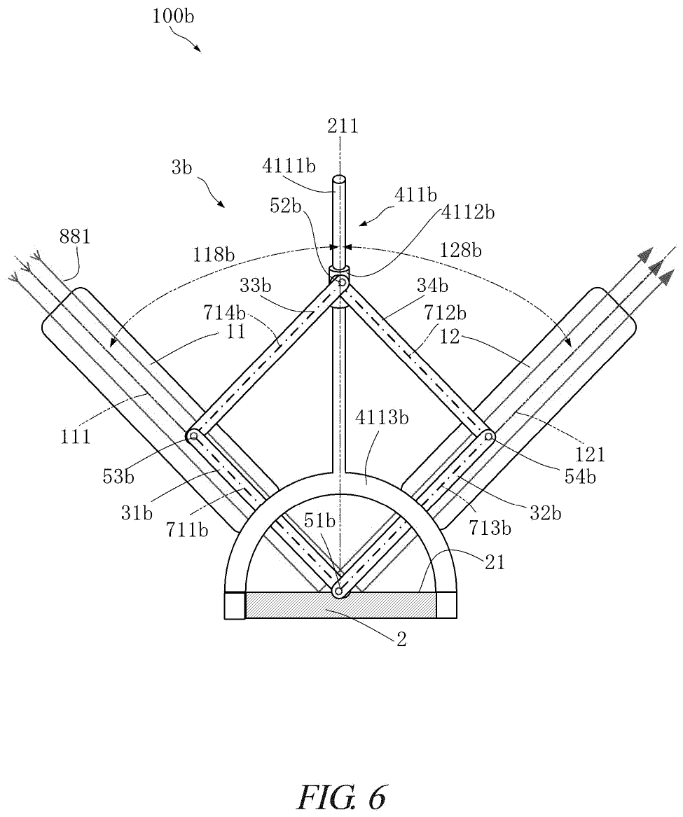

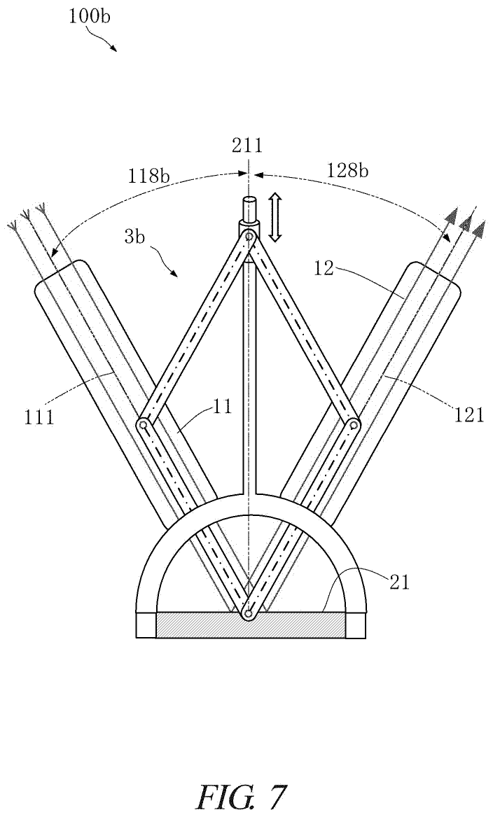

FIGS. 6 and 7 illustrate front views of an optical device according to another embodiment of the present disclosure.

The optical device 100b in FIGS. 6 and 7 may include the first optical path 11, the second optical path 12, the mirror 2, and a linkage system 3b. The optical paths 11 and 12 and the mirror 2 in FIGS. 6 and 7 are the same as or similar to those of FIGS. 2 and 3. In the embodiment of FIGS. 6 and 7, the linkage system 3b may include a first bar 31b, a second bar 32b, a third bar 33b, and a fourth bar 34b. In one embodiment, the bars 31b-34b may form a parallelogram.

In FIGS. 6 and 7, the bars 31b and 32b may pivotally connect at a first joint 51b, the bars 33b and 34b may pivotally connect at a second joint 52b, the bars 31b and 33b may pivotally connect at a third joint 53b, the bars 32b and 34b may pivotally connect at a fourth joint 54b.

In the illustrated example, the first joint 51b may be connected to the reflective surface 21, for example, without limitation, at a center of the reflective surface 21. The first optical axis 111 and the second optical axis 121 may cross at the first joint 51b and on the reflective surface 21. The second joint 52b may be connected to a slide structure 411b. Therefore, the second joint 52b may slidably move by the slide structure 411b. In FIGS. 6-7, the slide structure 411b may include a rod 4111b, a sliding tube 4112b, and an arch 4113b. Two feet of the arch 4113b may be fixed to the mirror 2. The arch 4113b may have slots to let the light pass through and let the optical paths 1 land 12 to tilt freely. The rod 4111b may extend, for example, parallel to or normal to the reflective surface 21 of the mirror 2. In the illustrated example, the rod 4111b may be connected to the arch 4113b. The rod 4111b may extend normal to the reflective surface 21 of the mirror 2, for example without limitation, from a top of the arch 4113b. The sliding tube 4112b may be connected to the rod 4111b, and be slidable along the rod 4111b. In other examples, the first slide structure may include: a channel and a sliding block slidable along the channel; a rail and a wheel slidable along the rail; or other similar linear sliding mechanisms.

In one embodiment, the second joint 52b may be constrained by the slide structure 411b, such that the bars 31b and 32b may pivot around the first joint 51b. In the illustrated example, the second joint 52b may be constrained to move normal to the reflective surface 21 of the mirror. As shown in FIGS. 6-7, when the bars 31b and 32b pivot around the first joint 51b, the first optical path 11 and the second optical path 12 may pivot around the first joint 51b. During the movement of the first optical path 11 relative to the second optical path 12, a line 711b extending from the first joint 51b to the third joint 53b may remain parallel to a line 712b extending from the fourth joint 54b to the second joint 52b. During the movement of the first optical path 11 relative to the second optical path 12, a line 713b extending from the first joint 51b to the fourth joint 54b may remain parallel to a line 714b extending from the third joint 53b to the second joint 52b.

In this embodiment, the pairs of the lines 711b-714b may remain parallel and the first optical axis 111 and the second optical axis 121 may pivot around the first joint 51b located on the reflective surface 21. Therefore, the first and second tilt angles 118b and 128b may remain the same during the movement of the first optical path 11 relative to the second optical path 12. As such, the chance of the light 881 not translating from an optical path (e.g., the second optical path 12) or de-centering from an optical path (e.g., the second optical path 12) may be decreased. Further, space for an optical system can be saved and/or reduction of the light amount until a targeted location may be suppressed. In addition, the linkage system 3b of FIGS. 6-7 may have more clearance at the bottom of the mirror 2 compared to the linkage system 3 in FIGS. 2-3 or the linkage system 3a in FIGS. 4-5.

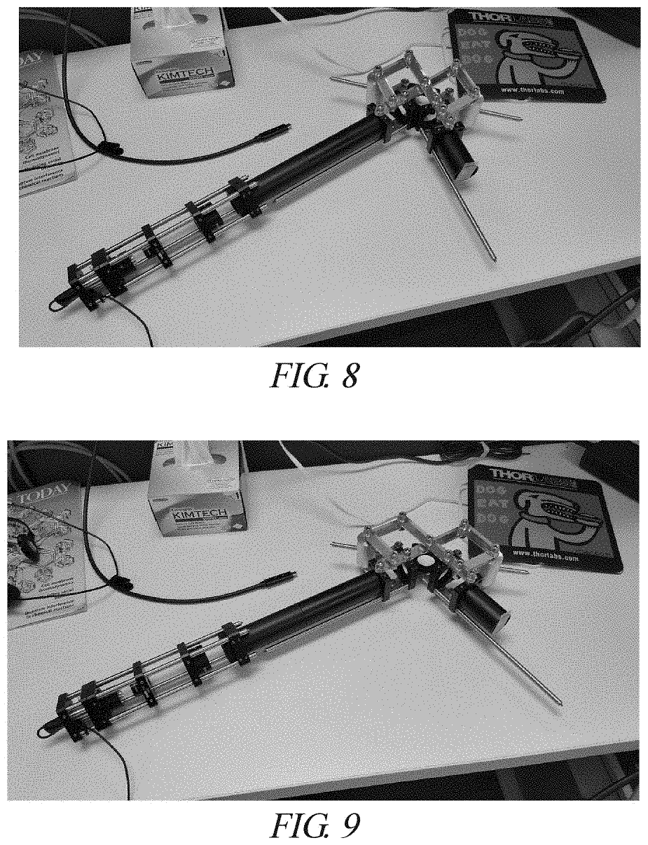

Each of FIGS. 8-9 shows a prototype of an optical device according to one embodiment of the present disclosure. In particular, the prototype of FIGS. 8-9 is based on the optical device 100 in FIGS. 2-3. In FIGS. 8-9, bottom left is a laser pointer generating a collimated beam through a first optical path such as a lens tube. To the right of the picture in FIGS. 8-9 is a second optical path such as an output lens tube. At the end of the second optical path such as the lens tube, a piece of a tape is disposed as a screen. When the second optical path such as the lens tube tilts relative to the first optical path such as the lens tube, the laser spot may stay at the same position on the screen (see FIG. 9).

Each of the optical devices 100, 100a, and 100b in FIGS. 2-7, which can be swivel joints, may have one rotational degree of freedom. The range of angular motion may be restricted due to the size of the mirror 2. However, each of the optical devices 100, 100a, and 100b can be combined with a regular rotary joint, linear sliding tube and additional swivel joints to allow up to six degree of freedom control on the light delivery. According to this structure, the number of mirrors required may be reduced to provide same degree of freedom control of light.

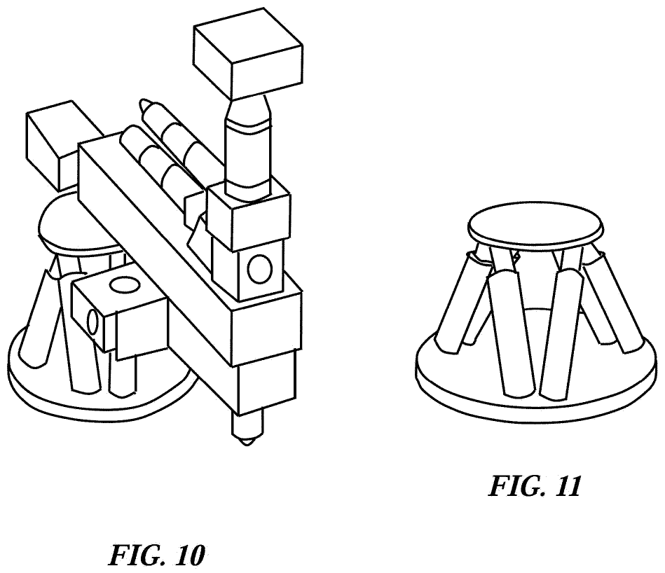

In non-limiting examples, the optical devices 100, 100a, and 100b of FIGS. 2-7 may be employed in an optical apparatus that includes a microscope with a light source. In non-limiting examples, the optical devices 100, 100a, and 100b may direct a light from the light source toward a desired location by having the light proceed along the first optical path 11 and the second optical path 12 (see FIGS. 2-7). The microscope and/or the optical devices 100, 100a, 100b may be mounted on a hexapod that provides six degrees of freedom. One example of such a microscope mounted on a hexapod is shown in FIG. 10. FIG. 11 is a perspective view of the hexapod shown in FIG. 11.

FIG. 10 illustrates a non-limiting example that a microscope is mounted on an adjustable stage, so that the entire microscope can be moved. The stage may include the hexapod that may provide six degrees of freedom (see FIG. 11). Although the microscope is shown as being mounted in the upright position, it is also possible to mount the microscope in an inverted position or sideway or angled position

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An optical device comprising:
a first optical path defined along a first optical axis;
a second optical path defined along a second optical axis;
a light reflective surface defined between the first and second optical paths, the first and second axes defining first and second tilt angles from a normal line of the reflective surface, respectively; and
a linkage system connecting the first and second optical paths with the light reflective surface such that the first tilt angle remains the same as the second tilt angle during movement of the first optical path relative to the second optical path.

2. The optical device of claim 1, wherein the linkage system comprises: first, second, third, and fourth bars,
wherein the first and second bars pivotally connect at a first joint, the third and fourth bars pivotally connect at a second joint, the first and third bars pivotally connect at a third joint, and the second and fourth bars pivotally connect at a fourth joint,
wherein during the movement of the first optical path relative to the second optical path, a line extending from the first joint to the third joint remains parallel to a line extending from the fourth joint to the second joint, and a line extending from the first joint to the fourth joint remains parallel to a line extending from the third joint to the second joint,
wherein the first and second optical axes cross at the first joint and on the light reflective surface, and
wherein movement of the second joint is constrained by a first slide structure such that the first and second optical axes pivot the first joint and that the first tilt angle remains the same as the second tilt title angle during movement of the first optical path relative to the second optical path.

3. The optical device of claim 2, wherein the first slide structure comprises: a rod and a sliding tube slidable along the rod; a channel and a sliding block slidable along the channel; or a rail and a wheel slidable along the rail.

4. The optical device of claim 2, wherein the first slide structure comprises: an arch having two feet that are fixed to the mirror; and a rod extending from a top of the arch, the rod being normal to the light reflective surface of the mirror.

5. The optical device of claim 2, wherein the second joint is constrained to move normal or parallel to the reflective surface of the mirror.

6. The optical device of claim 2, wherein the linkage system comprises fifth and sixth bars,
wherein the fifth and sixth bars pivotally connect at a fifth joint, the first and sixth bars pivotally connect at a seventh joint, and the second and fifth bars pivotally connect at a sixth joint,
wherein a line extending from the first joint to the seventh joint is parallel to a line extending from the sixth joint to the fifth joint, and a line extending from the first joint to the sixth joint is parallel to a line extending from the seventh joint to the fifth joint.

7. The optical device of claim 6, wherein the fifth joint is constrained by a second slide structure.

8. An optical apparatus, comprising:
a microscope including a light source; and
at least an optical device configured to direct a light from the light source;
wherein the optical device comprises:
a first optical path defined along a first optical axis;
a second optical path defined along a second optical axis;
a light reflective surface defined between the first and second optical paths, the first and second axes defining first and second tilt angles from a normal line of the reflective surface, respectively; and
a linkage system connecting the first and second optical paths with the light reflective surface such that the first tilt angle remains the same as the second tilt angle during movement of the first optical path relative to the second optical path.

9. The optical apparatus of claim 8, wherein the microscope or the optical device is mounted on a hexapod that provides six degrees of freedom.

10. The optical apparatus of claim 9, wherein the optical device is combined with a regular rotary joint, linear sliding tube and/or additional swivel joints to allow up to six degree of freedom control on the light delivery.

11. The optical apparatus of claim 8, further comprising a plurality of the optical devices connected in series and configured to direct the light from the light source to a destination.
